(19) United States
(12) Patent Application Publication
(10) Pub. No.: US 2020/0319843 A1
(43) Pub. Date: Oct. 8, 2020

(54) RECONFIGURABLE MICROPHONE ASSEMBLY

(71) Applicant: Knowles Electronics, LLC, Itasca, IL (US)

(72) Inventors: Wei-Wen Dai, Elgin, IL (US); William Ryan, Villa Park, IL (US)

(21) Appl. No.: 16/907,127

(22) Filed: Jun. 19, 2020

Related U.S. Application Data
(63) Continuation of application No. PCT/US2018/067562, filed on Dec. 26, 2018.
(60) Provisional application No. 62/611,230, filed on Dec. 28, 2017.

(51) Int. Cl. G06F 3/16; H04R 29/00; H04R 19/04

(52) U.S. Cl. CPC G06F 3/162; H04R 2201/003; H04R 19/04; H04R 29/004

(57) ABSTRACT

Disclosed herein are related to various embodiments of a reconfigurable transducer assembly and a method of operating the same. The transducer assembly includes a transducer and an electrical circuit coupled to the transducer. The transducer generates an electrical signal electrically representing a sensed result sensed by the transducer. The electrical circuit performs signal processing (e.g., sampling, amplification, filtering, etc.) on the electrical signal to obtain an output signal according to a process setting specifying how to perform the signal processing.

### CROSS-REFERENCE TO RELATED APPLICATION

The present application claims priority to U.S. Provisional Patent Application No. 62/611,230, filed Dec. 28, 2017, the contents of which are incorporated herein by reference in their entirety.

### FIELD OF THE DISCLOSURE

The present disclosure relates generally to transducer assemblies having a digital communication interface and more particularly to configuration of a communication protocol of the interface, and methods therefor.

### BACKGROUND

Microphones are deployed in various types of electronic devices such as cellular phones, mobile devices, headsets, hands free systems, smart televisions, smart speaker (e.g., Siri, Alexa), portable computers, etc. A microphone converts a sound into a corresponding electrical signal representing the sound. The microphone generates the electrical signal in an analog or digital format, and outputs the audio signal to a host device or processor.

The various aspects, features and advantages of the present disclosure will become more fully apparent to those having ordinary skill in the art upon consideration of the following Detailed Description and the accompanying drawings described below.

### SUMMARY

Various embodiments disclosed herein are related to a transducer assembly. In some embodiments, the transducer assembly includes a MEMS transducer, an electrical circuit coupled to the MEMS transducer, and a housing having an external-device interface with a fixed number of contacts. In some embodiments, the MEMS transducer and the electrical circuit are disposed at least partially within the housing. In some embodiments, the electrical circuit includes a protocol configuration circuit that configures the transducer assembly for a first communication protocol or a second communication protocol based on a signal received at the external-device interface. In some embodiments, the first communication protocol enables communication of digital acoustic data from the transducer assembly via the external-device interface and the second communication protocol enables diagnosis or configuration of the transducer assembly via the external-device interface.

In some embodiments, the external-device interface includes a number of contacts required to communicate via the external-device interface using the first communication protocol. In some embodiments, at least some of the contacts required to communicate using the first communication protocol are used to communicate using the second communication protocol.

In some embodiments, the external-device interface includes a clock contact, and the electrical circuit is adapted to configure a performance mode of the transducer assembly based on a frequency of an external clock signal received on the clock contact.

In some embodiments, the external-device interface includes a voltage supply contact, a ground contact and at least one other contact, and the protocol configuration circuit is adapted to configure the external-device interface for the first communication protocol or the second communication protocol based on a voltage level of a signal received at the other contact.

In some embodiments, the external-device interface includes contacts required for the first communication protocol and at least one contact required for the first communication protocol is used for the second communication protocol.

In some embodiments, the protocol configuration circuit is adapted to configure the external-device interface for the first communication protocol or the second communication protocol based on a frequency of an external clock signal received at the other contact.

In some embodiments, the external-device interface includes a voltage supply contact, a ground contact and at least one other contact, wherein at least some of the contacts are used for both the first communication protocol and for the second communication protocol.

In some embodiments, the MEMS transducer is an electro-acoustic transducer, and the electrical circuit is adapted to configure the transducer assembly in a first performance mode when a frequency of a clock signal received at the external-device interface is within one of a first frequency range, and configure the transducer assembly in a second performance mode when a frequency of a clock signal received at the external-device interface is within a second frequency range, and configure the transducer assembly for the first communication protocol or the second communication protocol when a frequency of a clock signal received at the external-device interface is within a third frequency range.

In some embodiments, the external-device interface includes only a voltage supply contact, a ground contact, a data contact, and a clock contact.

In some embodiments, the first communication protocol is PDM and the second communication protocol is VC.

In some embodiments, the protocol configuration circuit configures at least one contact of the external-device interface for the first communication protocol or the second communication protocol based on a configuration signal received at the external-device interface.

Various embodiments disclosed herein are related to a microphone assembly. In some embodiments, the microphone assembly includes a MEMS electro-acoustic transducer, an electrical circuit coupled to the MEMS electro-acoustic transducer, a housing including a base and a cover, the MEMS electro-acoustic transducer and the electrical circuit disposed at least partially within the housing, and an external-device interface with a fixed number of contacts disposed on an outer surface of the base. In some embodiments, the external-device interface includes contacts required for a first communication protocol. In some embodiments, the first communication protocol enables communication of digital acoustic data from the microphone assembly via the external-device interface. In some embodiments, the electrical circuit includes a protocol configuration circuit adapted to configure the microphone assembly for a second communication protocol based on a configuration signal received at the external-device interface. In some embodiments, the second communication protocol is different than the first communication protocol and at least some of the same contacts are used for the first communication protocol and the second communication protocol.

In some embodiments, the protocol configuration circuit is adapted to configure the microphone assembly based on a voltage signal received at the external-device interface.

In some embodiments, the protocol configuration circuit is adapted to configure the microphone assembly based on a frequency of a clock signal received at the external-device interface.

In some embodiments, the external-device interface includes only a voltage supply contact, a ground contact, a data contact, and a clock contact.

In some embodiments, the first communication protocol is PDM and the second communication protocol is I²C.

Various embodiments disclosed herein are related to a method in a microphone assembly including a MEMS transducer and an electrical circuit at least partially disposed in a housing having an external-device interface with contacts. In some embodiments, the method includes receiving a configuration signal at the external-device interface, and configuring functionality of the contacts of the external-device interface for communication pursuant to a first communication protocol or a second communication protocol in response to receiving the configuration signal. In some embodiments, at least some of the same contacts are used for communication pursuant to the first communication protocol and the second communication protocol. In some embodiments, the first communication protocol is different than the second communication protocol. In some embodiments, at least one of the first communication protocol or the second communication protocol is an audio signal protocol.

In some embodiments, the external-device interface includes a voltage supply contact, a ground contact and at least one other contact. In some embodiments, receiving the configuration signal includes receiving a clock signal at the other contact of the external-device interface. In some embodiments, the method further includes determining whether a frequency of the clock signal is indicative of a change in configuration of the external-device interface, and configuring the external-device interface when the frequency of the clock signal is indicative of a change in the configuration of the external-device interface.

In some embodiments, the external-device interface includes a voltage supply contact, a ground contact and at least one other contact. In some embodiments, receiving the configuration signal includes receiving a voltage signal at the other contact of the external-device interface. In some embodiments, the method further includes determining whether a level of the voltage signal is indicative of a change in configuration of the external-device interface, and configuring the external-device interface when the voltage signal is indicative of a change in the configuration of the external-device interface.

In some embodiments, the method further includes receiving a clock signal on a clock contact of the external-device interface, configuring a performance mode of the microphone assembly based on whether the clock signal has a first frequency corresponding to a first performance mode or a second frequency corresponding to a second performance mode, and configuring the external-device interface for the second communication protocol when the clock signal has a third frequency.

### BRIEF DESCRIPTION OF THE DRAWINGS

The disclosure is described in more detail below in connection with the appended drawings in which:

FIG. 1 is a schematic block diagram of an electronic device comprising microphone assembly connected to a host processor;

FIG. 2 is an internally exposed view of a digital microphone assembly;

FIG. 3 is a digital interface for a surface mount transducer assembly comprising a plurality of externally accessible contacts;

FIG. 4 is a schematic block diagram of a processing circuit of the digital microphone assembly;

FIG. 5 is a schematic block diagram of another processing circuit of the digital microphone assembly;

FIG. 6 is a schematic block diagram of another processing circuit of the digital microphone assembly;

FIG. 7 is a block diagram of a transducer driver of the processing circuit; and

FIG. 8 is a flow diagram illustrating a process of configuring a setting of a signal processing performed on an electrical sensing signal, and performing a signal processing on the electrical signal to generate an output signal.

### DETAILED DESCRIPTION

In the following, various exemplary embodiments are described with reference to the appended drawings. The skilled person will understand that the accompanying drawings are schematic and simplified for clarity and therefore merely show details which are essential to the understanding of the disclosure, while other details have been left out. Like reference numerals generally refer to like elements or components throughout. Like elements or components will therefore not necessarily be described in detail with respect to each figure. It will be appreciated further that certain actions or steps may be described or depicted in a particular order of occurrence while those skilled in the art will understand that such specificity with respect to sequence is not actually required unless so indicated.

The disclosure relates to reconfigurable transducer assemblies and methods of operating the same. In some embodiments, the transducer assembly includes a transducer and an electrical circuit coupled to the transducer. The transducer generates an electrical signal representing air pressure changes sensed by the transducer. The electrical signal is an unprocessed raw sensing signal produced by the transducer. The electrical circuit performs signal processing (e.g., amplification, buffering, filtering, sampling, etc.) on the electrical signal to obtain an output signal. The output signal is a processed signal (e.g., digitally processed) of the electrical signal.

In one or more embodiments, the transducer assembly may be configured to implement two or more communication protocols communicated through a fixed number (e.g., five) of contacts of an external-device interface. The communication protocol is changed in response to a configuration signal received via one or more contacts of the interface. The configuration signal indicates a target communication protocol from a plurality of communication protocols. In one embodiment, the first communication protocol is an acoustic signal protocol (e.g., SoundWire, PDM, etc.) and the second communication protocol is another acoustic signal protocol or some other known or future communication protocol (e.g., I²C, I²S, SPI, UART, etc.). In some implementations, the external-device interface includes contacts for the first communication protocol and the functionality of at least some of the contacts are changed in response to the configuration signal, wherein at least some of the same contacts are used by both the first and second communication protocols. Accordingly, the sharing of contacts permits reducing the overall number of contacts at the external-device interface of the transducer assembly.

In one or more embodiments, the processing performed on the electrical signal is reconfigurable. The transducer assembly may receive a process instruction indicating target process setting. The process setting indicates how to perform signal processing (e.g., filter configuration, gain setting, delay, timing, etc.). The transducer assembly may receive the process instruction through the second communication protocol (e.g., I²C, I²S, SPI, UART, etc.). The transducer assembly may perform signal processing on the electrical signal to generate the output signal according to the processing setting, and output the output signal through the first communication protocol (e.g., SoundWire, PDM, etc.).

The transducer assemblies or devices described herein may form part of a portable communication device or apparatus such as a smartphone, mobile phone, laptop computer, gaming device, inventory device, point of sale device, etc. Alternatively, the transducer assemblies may be used in a relatively stationary application, like in a gaming console, a desktop microphone, TOT device, or in an appliance, among other applications. The transducer assemblies may also be used in vehicles, other devices or systems. In other embodiments, the transducer assemblies are embodied as other sensors, like pressure, temperature, gas, and ultrasonic sensors. A transducer assembly may also include a combination of sensors, for example, an acoustic sensor and a pressure sensor, or an acoustic sensor in combination with another sensor like a temperature sensor and a gas sensor, among other sensors.

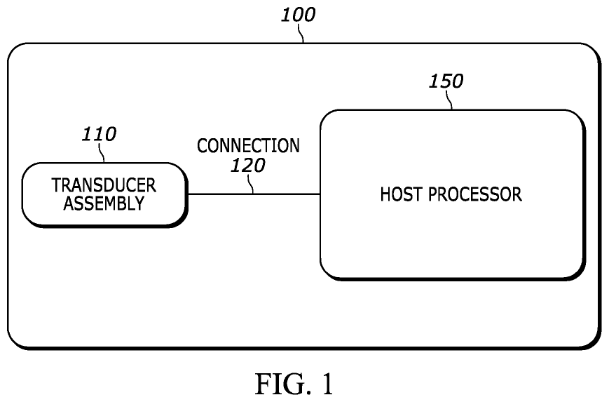

FIG. 1 is a schematic block diagram of an electronic device 100. The electronic device 100 includes a transducer assembly 110 and a host processor 150 connected to each other through a connection 120 (e.g., a communication bus). The transducer assembly 110 may be a microphone assembly configured to sense sound or may be another type of sensor. Each transducer assembly includes a plurality of externally accessible contacts that are electrically coupled to corresponding contacts of the host device, e.g., processor 150. The term “contact” herein refers to pins, pads, through-holes, sockets, etc. and any other conductive material that may be electrically coupled to a mating structure irrespective of the shape or configuration of the contact or the mechanism (e.g., soldering, friction fit, etc.), by which the electrical and mechanical coupling is achieved. Although one transducer assembly 110 is shown in FIG. 1, two or more number of transducer assemblies 110 may be integrated in or with the electronic device 100.

The transducer assembly 110 may be electrically and mechanically integrated with the host device or system by a carrier substrate implemented as a printed circuit board, flexible circuit board, socket or other interface. The carrier substrate generally includes wires or traces interconnecting a plurality of external contacts on an interface of the carrier substrate to corresponding buses of the host device or communication interface. The host processor, device or system could be coupled to contacts (e.g., a socket) on another interface of the carrier substrate. In embodiments where the carrier substrate is a circuit board, the wires or traces are integrally formed on or within the circuit board. In other embodiments, however, the wires or traces are not necessarily integrally formed on or with the carrier substrate. As suggested, the external contacts on the interface of the carrier substrate may be embodied as through-holes, pads, pins, sockets, etc., electrically connectable to corresponding contacts of the transducer assembly 110. Such an electrical connection may be realized using reflow, wave or manual soldering processes among other coupling means.

Generally, the transducer assembly 110 coupled to the carrier substrate communicates with the host device or system via a proprietary or standard communication protocol. Standard protocols include, for example, I²C, I²S, USB, UART and SPI among other known and future protocols. In FIG. 1, the transducer assembly 110 includes an external-device interface including contacts that are electrically coupled to the host device via a connection 120.

Consistent with the SoundWire protocol, the plurality of externally accessible contacts of each microphone assembly may include at least five contacts, in some embodiments. In some implementations, the contacts may include a power (VDD) contact, a ground (GND) contact, and three digital input/output (I/O) contacts. In some such implementations, the digital I/O contacts may be designated as Select, Clock (CLK), and Data contacts. The externally accessible contacts may be connected to corresponding contacts of the host processor 150 through the connection 120. In some implementations, the externally accessible contacts may correspond to a PDM pin-out (Select (LR), Clock (bit clock), Data, power (VDD), and ground (GND)) or a PCM pin-out (Word Select (WS), Clock (bit clock), Data, power (VDD), ground (GND)). In other implementations, the communication interface may have more or less contacts depending on the communication protocols implemented.

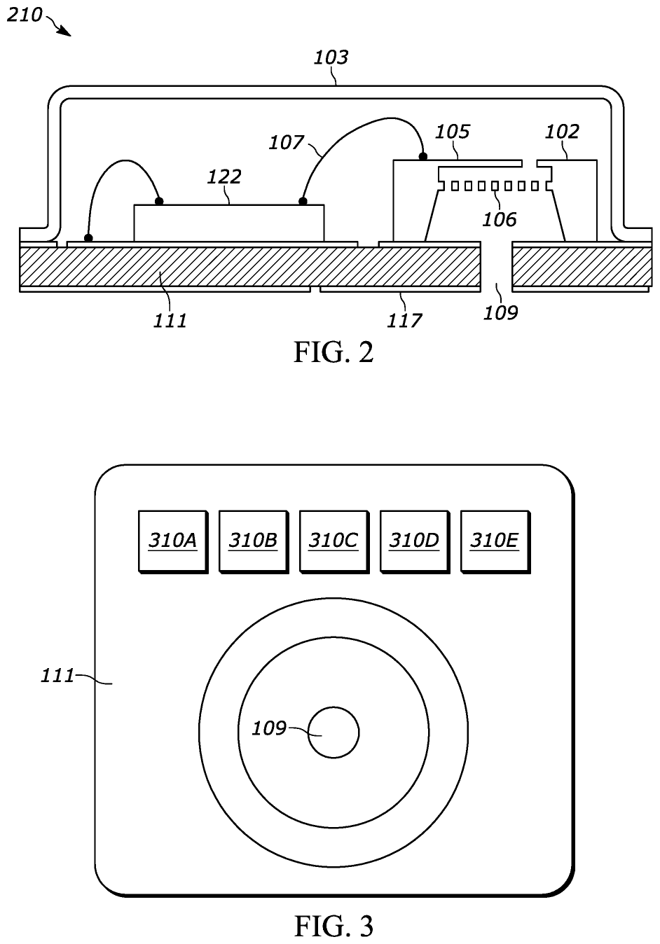

FIG. 2 illustrates an exemplary embodiment of a microphone assembly 210. The microphone assembly 210 is one illustrative implementation of the transducer assembly 110 of FIG. 1. The microphone assembly 210 includes a capacitive microelectromechanical system (MEMS) transducer 102. In microphone applications, the MEMS transducer 102 converts sensed acoustic energy into an electrical signal. In FIG. 2, the MEMS transducer 102 includes first and second transducer plates embodied as a diaphragm 105 and a back plate 106. A charge or bias is applied to the diaphragm 105 and back plate 106 by a DC charging circuit (not shown but well known). In other embodiments, the MEMS transducer 102 may be a piezo-electric transducer or some other known or future transducer, any one of which may be implemented as a MEMS die or as some other device.

The microphone assembly 210 also includes an electrical circuit (also referred to as a processing circuit) 122 which may be implemented as one or more semiconductor dice. In one implementation, the electrical circuit is implemented as a mixed-signal CMOS semiconductor device integrating analog and digital circuits. The MEMS transducer 102 and the processing circuit 122 are shaped and sized for mounting in the housing of the microphone assembly 210 as is known generally. The housing is formed by a lid 103 mounted on the substrate 111 (also referred to as “a carrier element 111”) such that the lid and substrate jointly form an interior volume or cavity within the housing enclosing and protecting the MEMS transducer 102 and the processing circuit 122. The housing includes a sound inlet or port 109 through the carrier element 111, or through the lid in other embodiments, for conveying acoustic energy to the MEMS transducer 102 as is known generally. The MEMS transducer 102 may include an output pad or terminal that is electrically coupled to the processing circuit 122 via one or more interconnecting wires 107. For surface mount devices, an essentially plane outwardly oriented lower surface 117 or external-device interface of the carrier element 111 includes a plurality of external contacts discussed above, an example of which is illustrated in FIG. 3.

The acoustic sensor of FIG. 2 is one example of a transducer assembly 110. In other implementations of the disclosure, the transducer assembly 110 could be embodied as a pressure sensor, a temperature sensor, a gas sensor, and an ultrasonic sensor, among other sensors that include an interface for communicating with a host or external device using a standard or proprietary protocol. The acoustic sensor could also be embodied as a combination of one or more of the foregoing sensors, for example, an acoustic sensor having integrated therewith one or more of a temperature sensor, a pressure sensor, a gas sensor, etc.

FIG. 3 illustrates a bottom view of the microphone assembly 210 having an interface including a plurality of externally accessible contacts 310A, 310B . . . 310E. Other microphone or transducer assemblies may include more or less contacts. Each of the contacts 310A through 310E may, for example, include a solder pad or bump for reflow soldering the transducer assembly onto a carrier substrate of a host device. As noted, the carrier substrate may be embodied as a printed circuit board, which may also support a host processor 150 and bus lines or wires (e.g., CLK and DATA among others depending on the protocol and the particular application) coupled to the host processor 150. In FIG. 3, the externally accessible contacts 310A through 310E are rectangular with substantially identical size and are spaced apart with a suitable pitch or separation. Contacts in other embodiments may have other shapes, arrangements and spacing. In FIG. 3, for example, the microphone assembly 210 may include an additional contact shaped as a circular solder-ring surrounding the sound port 109. The additional contact may be a ground connection of the microphone assembly 210.

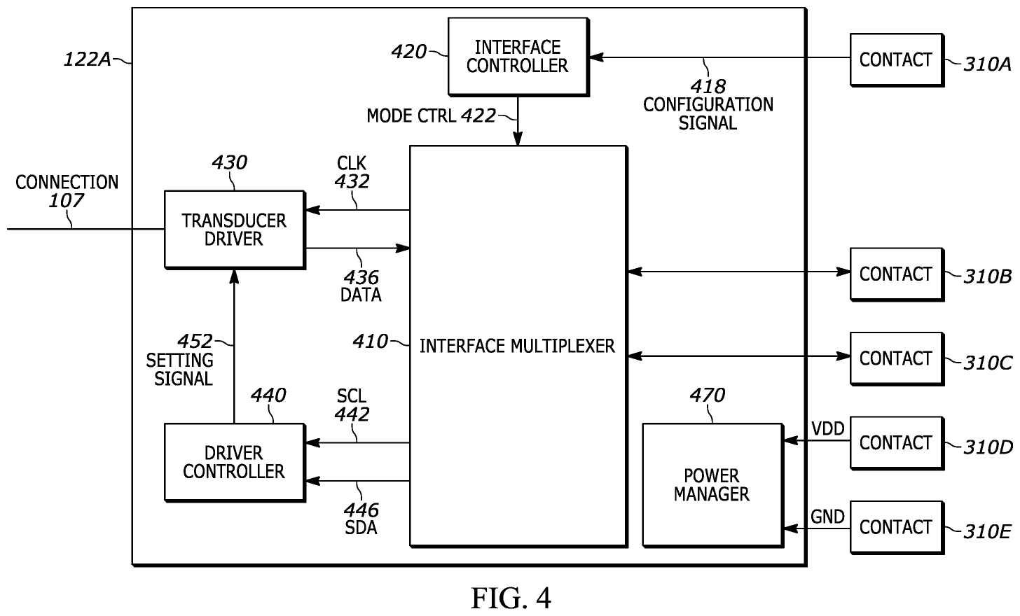

FIG. 4 is an electrical block diagram of a first exemplary embodiment of the processing circuit 122A of a transducer assembly 110, which may correspond to the microphone assembly 210 in FIG. 2 or to some other transducer assembly. In FIG. 4, the processing circuit 122A receives an electrical signal representing a sensed pressure signal (e.g., sensed audio) from the MEMS transducer 102 through the connection 107 (e.g., bonding wires). The processing circuit 122A generates an output signal upon processing (e.g., amplification, buffer, filtering, sampling, etc.) the electrical signal, and transmits the output signal through one or more of the contacts 310.

Generally, the transducer assembly 110 is configurable to communicate using different communication protocols based on receipt of an external configuration signal. Accordingly, the processing circuit 122A can be reconfigured and communicate with other devices through one or more of the contacts 310. In various implementations, the external configuration signal may be used to switch the transducer assembly 110 between an acoustic output mode (e.g., PDM, SoundWire, etc.) and a microphone configuration/interrogation mode (e.g., I²C).

The processing circuit 122A is an interface circuit between the MEMS transducer 102 and the contacts 310 for communicating with the host device. In some embodiments, the processing circuit 122A includes an interface multiplexer 410, an interface controller 420 (also referred to as “a protocol configuration circuit 420” herein), a transducer driver 430, and a driver controller 440. These components are coupled to each other through conductive wires or traces and operate together to receive the electrical signal through the connection 107 and configure the transducer assembly to communicate using to a first communication protocol or a second communication protocol. In one aspect, the processing circuit 122A communicates with the host processor 150 in a first communication protocol (e.g., SoundWire) to transmit the output signal through one or more of the contacts 310, and communicates with the host processor 150 in a second communication protocol (e.g., I²C) to receive a process instruction through one or more of the contacts 310. In other embodiments, the processing circuit 122A includes more, fewer, or different components than shown in FIG. 4.

The interface controller 420 is a circuit configuring a communication mode of the processing circuit 122A. In the embodiment shown in FIG. 4, the interface controller 420 is electrically coupled to the contact 310A and the interface multiplexer 410. In one aspect, the interface controller 420 receives a configuration signal 418 indicating whether the processing circuit 122A should communicate in a first communication protocol or a second communication protocol. The configuration signal 418 may be generated by the host processor 150 and transmitted through the connection 120. In one approach, the configuration signal 418 indicates a target communication mode by a voltage of a signal received at the contact 310A. For example, the configuration signal 418 having a voltage level of a ground GND or power VDD indicates that the processing circuit 122A should communicate in a first communication protocol, and a voltage level of a reference voltage (e.g., VDD/2) indicates that the processing circuit 122A should communicate in a second communication protocol (I²C). The interface controller 420 may include a voltage level detector and detect a voltage level of the configuration signal 418 to detect a target communication mode. Moreover, the interface controller 420 generates a mode control signal 422 indicating a target configuration of the interface multiplexer 410 according to the determined target communication mode. For example, the interface controller 420 generates the mode control signal 422 having a voltage level of at or near GND (e.g., within a threshold level of the defined GND level, such as within 10% of GND) in response to determining that the target communication mode is for a first communication protocol (e.g., an acoustic output protocol, such as SoundWire), and generates the mode control signal 422 having a voltage level of at or near VDD (e.g., within a threshold level of VDD, such as within 10% of VDD) in response to determining that the target communication mode is for a second communication protocol (e.g., a configuration/interrogation protocol, such as I²C).

The interface multiplexer 410 is a multiplexer circuit exchanging communication among the contacts 310, the transducer driver 430 and the driver controller 440. In the embodiment shown in FIG. 4, the interface multiplexer 410 is electrically coupled to the interface controller 420 and the contacts 310B, 310C. According to the mode control signal 422, the interface multiplexer 410 electrically couples the contacts 310B, 310C to the transducer driver 430 or to the driver controller 440. For example, in response to a first voltage level (e.g., GND) of the mode control signal 422, the interface multiplexer 410 may electrically couple the contacts 310B, 310C to the transducer driver 430 for communication compliant with a first communication protocol (e.g., SoundWire). In response to a second voltage level (e.g., VDD) of the mode control signal 422, the interface multiplexer 410 may electrically couple the contacts 310B, 310C to the driver controller 440 for communication compliant with a second communication protocol (e.g., I²C).

The driver controller 440 is a circuit that stores a process setting and configures the transducer driver 430 according to the process setting. Examples of the process settings of the transducer driver 430 include sensitivity, dynamic range, settings of digital filter, setting for wind noise reduction filter, time constants, drive strength, etc. In one embodiment, the driver controller 440 is electrically coupled to the transducer driver 430 and the interface multiplexer 410. When the interface multiplexer 410 is configured to electrically couple the driver controller 440 to the contacts 310B, 310C, the driver controller 440 receives a SCL signal 442, for example, through the contact 310B and a SDA signal 446, for example, through the contact 310C. The SCL signal 442 and the SDA signal 446 may be signals compliant with the I²C protocol. The SDA signal 446 may be a process instruction digitally indicating process settings, and the SCL signal 442 may be a clock signal indicating timing of how to sample the SDA signal 446. The driver controller 440 samples the SDA signal 446 according to timing information indicated by the SCL signal 442 to retrieve the process setting from the SDA signal 446, and stores the process setting. Moreover, the driver controller 440 generates a setting signal 452 electrically indicating the process setting, and provides the setting signal 452 to the transducer driver 430.

The transducer driver 430 is a circuit configured to perform processing on an electrical signal to generate an output signal. In one embodiment, the transducer driver 430 is electrically coupled to the MEMS transducer 102 through the connection 107 (e.g., bonding wire) to receive the electrical signal. In addition, the transducer driver 430 is electrically coupled to the driver controller 440 to receive the setting signal 452, and performs processing (e.g., sampling, amplification, filtering, etc.) on the electrical signal to generate a DATA signal 436 as an output signal according to a process setting indicated by the setting signal 452. When the interface multiplexer 410 is configured to electrically couple the transducer driver 430 to the contacts 310B, 310C, the transducer driver 430 receives a CLK signal 432, for example, through the contact 310B and outputs the DATA signal 436, for example, through the contact 310C. The CLK signal 432 and the DATA signal 436 may be signals compliant with SoundWire protocol. The CLK signal 432 may be a clock signal indicating timing of how to sample the electrical signal and how to generate the DATA signal 436. The transducer driver 430 samples the electrical signal and processes the sampled signal according to timing information indicated by the CLK signal 432 to generate the DATA signal 436. Moreover, the transducer driver 430 provides the DATA signal 436, for example, to the contact 310C through the interface multiplexer 410.

In one aspect, the transducer driver 430 is operable to be placed in one of multiple different configuration modes according to process setting indicated by the setting signal 452. In some embodiments, the transducer driver 430 may detect a frequency of the CLK signal 432 and automatically configure a performance of the transducer driver 430 according to the detected frequency. In one example, the transducer driver 430 operates in a high performance mode with a clock rate of the CLK signal 432 at a frequency range near 1 MHz (e.g., 900 kHz˜1.1 MHz) and a signal to noise ratio (SNR) larger than 65 dB. Additionally, the transducer driver 430 can operate in a low power mode with lower current consumption with a lower SNR than in the high performance mode at a clock rate of the CLK signal 432 at a frequency range near 256 kHz (e.g., 230 kHz˜281 kHz) or a frequency range near 768 kHz (e.g., 691 kHz˜844 kHz). Generally, SNR and power consumption decreases as the frequency of the CLK signal 432 decreases. Other process settings of the transducer driver 430 such as sensitivity, dynamic range, settings of digital filter, setting for wind noise reduction filter, time constants, drive strength may be adjusted according to the setting signal 452 generated by the driver controller 440.

The power manager 470 is a circuit that supplies power to components in the processing circuit 122A. In one embodiment, the power manager 470 is electrically coupled to contacts 310D, 310E. In one implementation, the power manager 470 receives power VDD through the contact 310D and connects to ground GND through the contact 310E. The power manager 470 distributes power VDD and ground GND to components of the processing circuit 122.

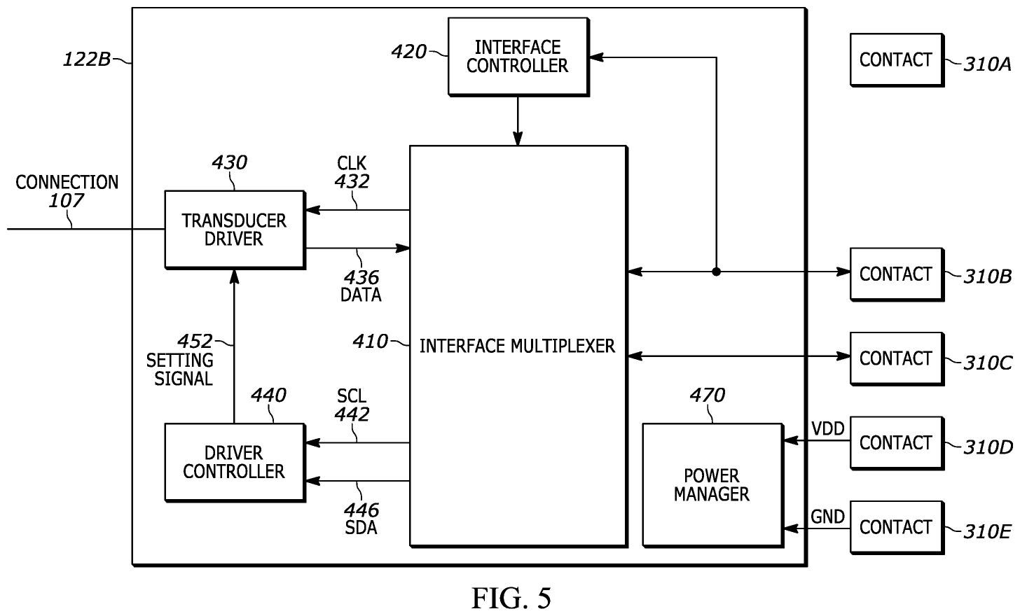

FIG. 5 is a schematic block diagram of the processing circuit 122B according to another embodiment. The processing circuit 122B is similar to the processing circuit 122A of FIG. 4, except the interface controller 420 is coupled to the contact 310B instead of the contact 310A and the contact 310A. Thus, detailed description of the duplicative portions is omitted herein for the sake of brevity. Advantageously, the processing circuit 122B employs a fewer number of contacts than the processing circuit 122A of FIG. 4.

In FIG. 5, the interface controller 420 is connected to the interface multiplexer 410 and the contact 310B, and determines a communication mode according to a frequency of a signal at the contact 310B. In one embodiment, the interface controller 420 includes a frequency detector that detects a frequency of a signal at the contact 310B, and determines a communication mode according to the detected frequency. In the embodiment shown in FIG. 5, the configuration signal is a combination of the CLK signal 432 and the SCL signal 442 at the contact 310B. The CLK signal 432 may be a clock signal compliant with SoundWire protocol having a frequency of 1 MHz, 256 kHz, 384 kHz, 512 kHz, or 768 kHz. The SCL signal 442 may be a clock signal compliant with I²C protocol having a frequency of 100 kHz, 400 kHz, or 800 kHz. Hence, if the frequency of a signal at the contact 310B is one of 100 kHz, 400 kHz, or 800 kHz, the interface controller 420 generates the mode control signal 422 to cause the interface multiplexer 410 to electrically couple the driver controller 440 to the contacts 310B, 310C. Similarly, if the frequency of a signal at the contact 310B is one of 1 MHz, 256 kHz, 384 kHz, 512 kHz, or 768 kHz, then the interface controller 420 generates the mode control signal 422 to cause the interface multiplexer 410 to electrically couple the transducer driver 430 to the contacts 310B, 310C.

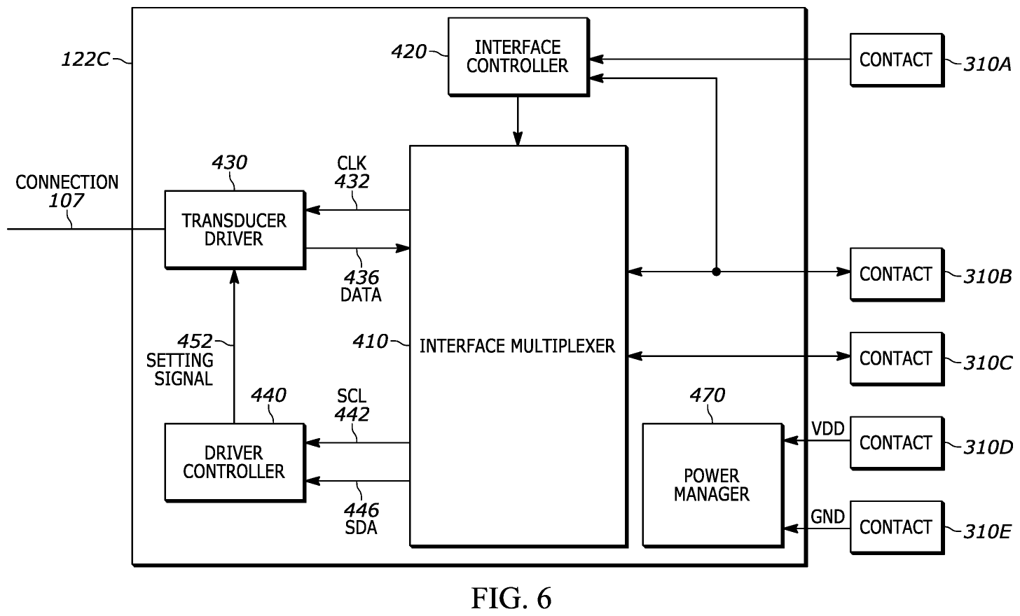

FIG. 6 is a schematic block diagram of the processing circuit 122C according to another embodiment. The processing circuit 122C is similar to the processing circuit 122B of FIG. 5, except the interface controller 420 is coupled to the contact 310A in addition to the contact 310B. In this embodiment, the interface controller 420 may include both a voltage detector and a frequency detector. Therefore, the processing circuit 122C can detect a communication mode based on a voltage of a signal at the contact 310A as described above with respect to FIG. 4 and/or a frequency of a signal at the contact 310B as described above with respect to FIG. 5. Thus, detailed description of the duplicative portions is omitted herein for the sake of brevity.

In some embodiments, the processing circuit 122 is embodied as a field programmable gate array to implement functionalities of the processing circuit 122 described herein. In other embodiments, the processing circuit 122 is implemented as a processor and a non-transitory computer readable medium storage including instructions, when executed, cause the processor to perform functionalities of the processing circuit 122 described herein.

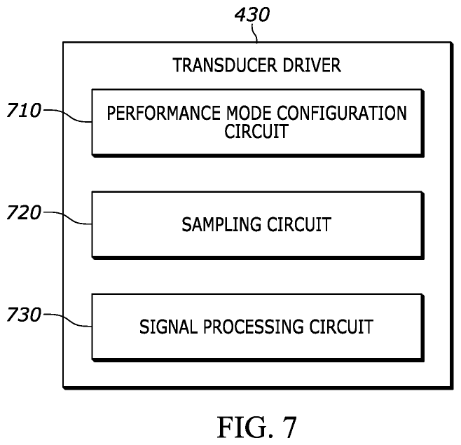

Referring to FIG. 7, illustrated is a block diagram of a transducer driver 430. In one embodiment, the transducer driver 430 includes a performance mode configuration circuit 710, a sampling circuit 720, and a signal processing circuit 730. These components operate together to receive an electrical signal and perform signal processing on the electrical signal to generate an output signal. In other embodiments, the transducer driver 430 includes more, fewer, or different components than shown in FIG. 7.

The performance mode configuration circuit 710 is a circuit that configures operating parameters of the sampling circuit 720 or the signal processing circuit 730. In one embodiment, the performance mode configuration circuit 710 is coupled to the driver controller 440, and receives the setting signal 452 electrically indicating the process setting. According to sensitivity, dynamic range, settings of digital filter, setting for wind noise reduction filter, time constants, drive strength, etc., as indicated by the setting signal, the performance mode configuration circuit 710 configures operating conditions of the sampling circuit 720 and the signal processing circuit 730, accordingly.

The sampling circuit 720 is a circuit that receives the electrical signal and converts the electrical signal represented in analog format into a digital format. The sampling circuit 720 may include an analog-to-digital converter that samples the electrical signal according to timing information of the CLK signal 432, and quantizes the sampled signal into corresponding digital representations. The quantization level may be configured according to a target sensitivity, or a target dynamic range as indicated by the process setting from the driver controller 440.

The signal processing circuit 730 is a circuit that receives the converted signal from the sampling circuit 720 and performs signal processing on the digitally converted signal. Examples of the signal processing include amplification, digital filtering, encoding, encryption, etc. Parameters such as a target cut-off frequency, a target bandwidth, a target pass band gain, a target attenuation level, a target encoding type, a target encryption key, etc. for performing signal processing may be indicated by the process setting from the driver controller 440. The signal processing circuit 730 performs signal processing on the converted signal according to the parameters indicated by the process setting to generate the DATA signal 436, and may output the DATA signal 436 to the contact 310C through the interface multiplexer 410.

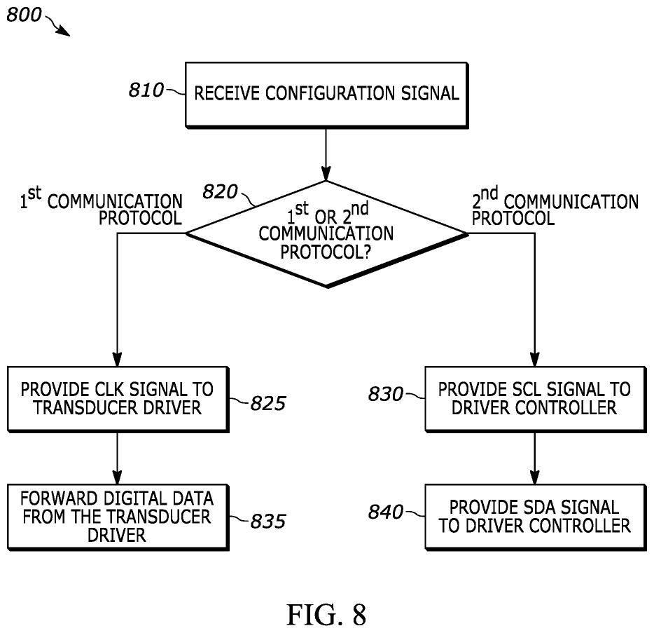

FIG. 8 is a flow chart showing a process 800 for configuring a setting of a signal process to be performed on an electrical signal, and performing a signal processing on the electrical signal according to the process setting. The process 800 in FIG. 8 may be performed by the interface controller 420 and the interface multiplexer 410. In other embodiments, the process 800 may be performed by other entities. In other embodiments, the process 800 includes more, fewer, or different steps than shown in FIG. 8.

The interface controller 420 receives a configuration signal (810). The configuration signal may be a signal received at the contact 310A indicating a target communication mode by a voltage of the signal. For example, the configuration signal having a voltage level of a reference voltage (e.g., VDD/2) indicates that the interface multiplexer 410 should communicate in a first communication protocol, such as an acoustic output protocol in which acoustic data is output through the interface multiplexer 410 (e.g., SoundWire), and a voltage level of a ground GND or power VDD indicates that the interface multiplexer 410 should communicate in a second communication protocol, such as a configuration/interrogation protocol in which data is input through the interface multiplexer 410 (e.g., I²C). Alternatively or additionally, the configuration signal is a combination of the SCL signal 442 having one of a set of first frequencies (e.g., 1 MHz, 256 kHz, 384 kHz, 512 kHz, or 768 kHz) compliant with a first communication protocol (e.g., SoundWire) and the CLK signal 432 having one of a set of second frequencies (e.g., 100 kHz, 400 kHz, or 800 kHz) compliant with a second communication protocol (e.g., I²C) at the contact 310B. According to the voltage level of the signal at the contact 310A or a frequency of the signal at the contact 310B, the interface controller 420 determines a communication mode (820).

In response to determining that the communication mode is for a first communication protocol (e.g., SoundWire protocol), the interface controller 420 configures the interface multiplexer 410 in a first communication mode. In particular, the interface multiplexer 410 couples the contacts 310B, 310C to the transducer driver 430 instead of the driver controller 440. Hence, the interface multiplexer 410 receives the CLK signal 432 from the contact 310B, and provides the CLK signal 432 to the driver controller 440 (825). In response to timing information indicated by the CLK signal 432, the transducer driver 430 samples the electrical signal and performs signal processing on the sampled signal to generate the DATA signal 436. In addition, the interface multiplexer 410 receives the DATA signal 436 from the transducer driver 430, and forwards the DATA signal 436 to the contact 310C (835).

In response to determining that the communication mode is for a second communication protocol (e.g., I²C protocol), the interface controller 420 configures the interface multiplexer 410 in a second communication mode. In particular, the interface multiplexer 410 couples the contacts 310B, 310C to the driver controller 440 instead of the transducer driver 430. Hence, the interface multiplexer 410 receives the SCL signal 442 from the contact 310B, and provides the SCL signal 442 to the driver controller 440 (830). In addition, the interface multiplexer 410 receives the SDA signal 446 from the contact 310C, and provides the SDA signal 446 to the driver controller 440 (840). According to the SCL signal 442 and the SDA signal 446, the driver controller 440 may update the process setting.

Advantageously, the process circuit 122 can communicate with an external device (e.g., host processor 150) via two or more different communication protocols through a limited number of contacts 310, where one or more contacts for transmitting the output signal in one communication protocol (e.g., SoundWire) is reused for receiving signals in another communication protocol (e.g., I²C) for modifying process settings of the process circuit 122 or performing diagnosis of the transducer assembly.

Various embodiments of a transducer assembly are disclosed herein. The transducer assembly includes a MEMS transducer; an electrical circuit coupled to the transducer; and a housing having an external-device interface with a fixed number of contacts. The transducer and the electrical circuit are disposed at least partially within the housing. The electrical circuit includes a protocol configuration circuit that configures the microphone assembly for a first communication protocol or a second communication protocol based on a signal received at the external-device interface. The first communication protocol enables communication of digital acoustical data from the microphone assembly via the external-device interface and the second communication protocol enables diagnosis or configuration of the microphone assembly via the external-device interface.

Various embodiments of a transducer assembly are disclosed herein. The transducer assembly includes a MEMS transducer, an electrical circuit coupled to the transducer, a housing including a base and a cover. The transducer and the electrical circuit are disposed at least partially within the housing. The transducer assembly further includes an external-device interface with a fixed number of contacts disposed on an outer surface of the base. The external-device interface includes a minimum number of contacts required for a first communication protocol. The first communication protocol enables communication of digital acoustic data from the microphone assembly via the external-device interface. The electrical circuit includes a protocol configuration circuit adapted to configure the external-device interface for a second communication protocol based on a configuration signal received at the external-device interface. The second communication protocol is different than the first communication protocol.

Various embodiments of a method performed in a transducer assembly including a MEMS transducer and an electrical circuit at least partially disposed in a housing having an external-device interface with a minimum number of contacts required for communication pursuant to a first communication protocol are disclosed herein. The method includes receiving a configuration signal at the external-device interface. The method further includes configuring the external-device interface for communication pursuant to a second communication protocol in response to receiving the configuration signal. The first communication protocol is different than the second communication protocol.

While the present disclosure and what is presently considered to be the best mode thereof has been described in a manner that establishes possession by the inventors and that enables those of ordinary skill in the art to make and use the same, it will be understood and appreciated that there are many equivalents to the exemplary embodiments disclosed herein and that myriad modifications and variations may be made thereto without departing from the scope and spirit of the disclosure, which is to be limited not by the exemplary embodiments but by the appended claims.

What is claimed is:

1. A transducer assembly comprising:
a MEMS transducer;
an electrical circuit coupled to the MEMS transducer; and
a housing having an external-device interface with a fixed number of contacts, the MEMS transducer and the electrical circuit disposed at least partially within the housing, the electrical circuit including a protocol configuration circuit that configures the transducer assembly for a first communication protocol or a second communication protocol based on a signal received at the external-device interface,
wherein the first communication protocol enables communication of digital acoustic data from the transducer assembly via the external-device interface and the second communication protocol enables diagnosis or configuration of the transducer assembly via the external-device interface.

2. The transducer assembly of claim 1, wherein the external-device interface includes a number of contacts required to communicate via the external-device interface using the first communication protocol, and wherein at least some of the contacts required to communicate using the first communication protocol are used to communicate using the second communication protocol.

3. The transducer assembly of claim 2, wherein the external-device interface includes a clock contact, and the electrical circuit is adapted to configure a performance mode of the transducer assembly based on a frequency of an external clock signal received on the clock contact.

4. The transducer assembly of claim 1, wherein:
the external-device interface includes a voltage supply contact, a ground contact and at least one other contact, and
the protocol configuration circuit is adapted to configure the external-device interface for the first communication protocol or the second communication protocol based on a voltage level of a signal received at the other contact.

5. The transducer assembly of claim 4, wherein the external-device interface includes contacts required for the first communication protocol and at least one contact required for the first communication protocol is used for the second communication protocol.

6. The transducer assembly of claim 1, wherein the protocol configuration circuit is adapted to configure the external-device interface for the first communication protocol or the second communication protocol based on a frequency of an external clock signal received at the other contact.

7. The transducer assembly of claim 6, the external-device interface including a voltage supply contact, a ground contact and at least one other contact, wherein at least some of the contacts are used for both the first communication protocol and for the second communication protocol.

8. The transducer assembly of claim 1, wherein the MEMS transducer is an electro-acoustic transducer, and the electrical circuit is adapted to:
configure the transducer assembly in a first performance mode when a frequency of a clock signal received at the external-device interface is within one of a first frequency range;
configure the transducer assembly in a second performance mode when a frequency of a clock signal received at the external-device interface is within a second frequency range; and
configure the transducer assembly for the first communication protocol or the second communication protocol when a frequency of a clock signal received at the external-device interface is within a third frequency range.

9. The transducer assembly of claim 1, the external-device interface includes only a voltage supply contact, a ground contact, a data contact, and a clock contact.

10. The transducer assembly of claim 9, the first communication protocol is PDM and the second communication protocol is I²C.

11. The transducer assembly of claim 1, wherein the protocol configuration circuit configures at least one contact of the external-device interface for the first communication protocol or the second communication protocol based on a configuration signal received at the external-device interface.

12. A microphone assembly comprising:
a MEMS electro-acoustic transducer;
an electrical circuit coupled to the MEMS electro-acoustic transducer;
a housing including a base and a cover, the MEMS electro-acoustic transducer and the electrical circuit disposed at least partially within the housing; and
an external-device interface with a fixed number of contacts disposed on an outer surface of the base, the external-device interface including contacts required for a first communication protocol, the first communication protocol enabling communication of digital acoustic data from the microphone assembly via the external-device interface, the electrical circuit including a protocol configuration circuit adapted to configure the microphone assembly for a second communication protocol based on a configuration signal received at the external-device interface,
wherein the second communication protocol is different than the first communication protocol and at least some of the same contacts are used for the first communication protocol and the second communication protocol.

13. The microphone assembly of claim 12, wherein the protocol configuration circuit is adapted to configure the microphone assembly based on a voltage signal received at the external-device interface.

14. The microphone assembly of claim 12, wherein the protocol configuration circuit is adapted to configure the microphone assembly based on a frequency of a clock signal received at the external-device interface.

15. The microphone assembly of claim 12, the external-device interface includes only a voltage supply contact, a ground contact, a data contact, and a clock contact.

16. The microphone assembly of claim 15, the first communication protocol is PDM and the second communication protocol is VC.

17. A method in a microphone assembly including a MEMS transducer and an electrical circuit at least partially disposed in a housing having an external-device interface with contacts, the method comprising:
receiving a configuration signal at the external-device interface; and
configuring functionality of the contacts of the external-device interface for communication pursuant to a first communication protocol or a second communication protocol in response to receiving the configuration signal, at least some of the same contacts used for communication pursuant to the first communication protocol and the second communication protocol, the first communication protocol different than the second communication protocol, wherein at least one of the first communication protocol or the second communication protocol is an audio signal protocol.

18. The method of claim 17, wherein:
the external-device interface includes a voltage supply contact, a ground contact and at least one other contact,
wherein receiving the configuration signal includes receiving a clock signal at the other contact of the external-device interface, the method further including:
determining whether a frequency of the clock signal is indicative of a change in configuration of the external-device interface; and
configuring the external-device interface when the frequency of the clock signal is indicative of a change in the configuration of the external-device interface.

19. The method of claim 17,
wherein the external-device interface includes a voltage supply contact, a ground contact and at least one other contact,
wherein receiving the configuration signal includes receiving a voltage signal at the other contact of the external-device interface,
wherein the method further comprises:
determining whether a level of the voltage signal is indicative of a change in configuration of the external-device interface; and
configuring the external-device interface when the voltage signal is indicative of a change in the configuration of the external-device interface.

20. The method of claim 17, further comprising:
receiving a clock signal on a clock contact of the external-device interface;
configuring a performance mode of the microphone assembly based on whether the clock signal has a first frequency corresponding to a first performance mode or a second frequency corresponding to a second performance mode; and
configuring the external-device interface for the second communication protocol when the clock signal has a third frequency.
